(19) United States
(12) Patent Application Publication
(10) Pub. No.: US 2024/0109140 A1
(43) Pub. Date: Apr. 4, 2024

(54) JIGSAW

(71) Applicant: MILWAUKEE ELECTRIC TOOL CORPORATION, Brookfield, WI (US)

(72) Inventors: John M. JUBECK, Mequon, WI (US); Joesph G. BLOOMFIELD, Wauwatosa, WI (US); Ryan D. MOORLEGHEN, Milwaukee, WI (US); Andrew J. WEBER, Cudahy, WI (US); Wu FAN, Dongguan City (CN)

(21) Appl. No.: 18/476,845

(22) Filed: Sep. 28, 2023

(30) Foreign Application Priority Data
Sep. 29, 2022 (CN) 202222598490.2

(51) Int. Cl. B23D 49/16; B23D 51/03

(52) U.S. Cl. CPC B23D 49/162; B23D 51/03

(57) ABSTRACT

A jigsaw including a housing, a drive assembly disposed within the housing and selectively driven by a power source, an output spindle to which a saw blade is attachable and driven in a reciprocating manner by the drive assembly, a foot plate coupled to the housing and configured to support the housing relative to a workpiece during a cutting operation, and a shoe removably coupled to the foot plate and configured to contact the workpiece during a cutting operation. The shoe includes a blade accommodating region within which at least one replacement saw blade is receivable for storage.

### FIELD OF THE INVENTION

The present invention relates to power tools, and more specifically to jigsaws.

### BACKGROUND OF THE INVENTION

Various power tools, such as jigsaws, rest or slide against a workpiece during operation. As a result, the workpiece can become marred or damaged. An anti-marring shoe may be disposed between the workpiece and the power tool to inhibit inadvertent damage to the workpiece.

### SUMMARY OF THE INVENTION

The present invention provides, in one aspect, a jigsaw including a housing, a drive assembly disposed within the housing and selectively driven by a power source, an output spindle to which a saw blade is attachable and driven in a reciprocating manner by the drive assembly, a foot plate coupled to the housing and configured to support the housing relative to a workpiece during a cutting operation, and a shoe removably coupled to the foot plate and configured to contact the workpiece during a cutting operation. The shoe includes a blade accommodating region within which at least one replacement saw blade is receivable for storage.

The present invention provides, in another aspect, a shoe for use with a jigsaw. The jigsaw includes a housing, a foot plate configured to support the housing on a workpiece, and a saw blade driven in a reciprocating manner relative to the foot plate. The shoe includes a bottom surface configured to face and abut the workpiece, a top surface opposite the bottom surface, and a rear wall and a front wall, both of which extend upward from the top surface to encase at least a portion of the foot plate. The shoe further includes a first side wall and a second side wall, both of extend between the rear wall and the front wall. The shoe further includes a blade accommodating region disposed adjacent the top surface configured to receive at least one replacement saw blade for storage, wherein the blade accommodating region is disposed between the top surface and the foot plate.

Other features and aspects of the invention will become apparent by consideration of the following detailed description and accompanying drawings.

### BRIEF DESCRIPTION OF THE DRAWINGS

FIG. 1 is plan view of a jigsaw in accordance with an embodiment of the invention.

FIG. 2 is a partially exploded perspective view of the jigsaw of FIG. 1.

FIG. 3 is a partially exploded perspective view of the jigsaw of FIG. 1, illustrating an anti-marring shoe removed from a foot plate of the jigsaw and a plurality of blades receivable within the shoe.

FIG. 4 is a perspective view of the shoe of FIG. 3.

FIG. 5 is a cross-sectional view of the jigsaw of FIG. 1 along section line 5-5 of FIG. 2, illustrating the blades received within the shoe.

FIG. 6 is top plan view of the shoe, illustrating a blade accommodating region disposed on a top surface of the shoe.

FIG. 7 is a bottom plan view of the shoe, illustrating a bottom surface.

FIG. 8 is a top perspective view of the shoe, illustrating the blades disposed within the blade accommodating region.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

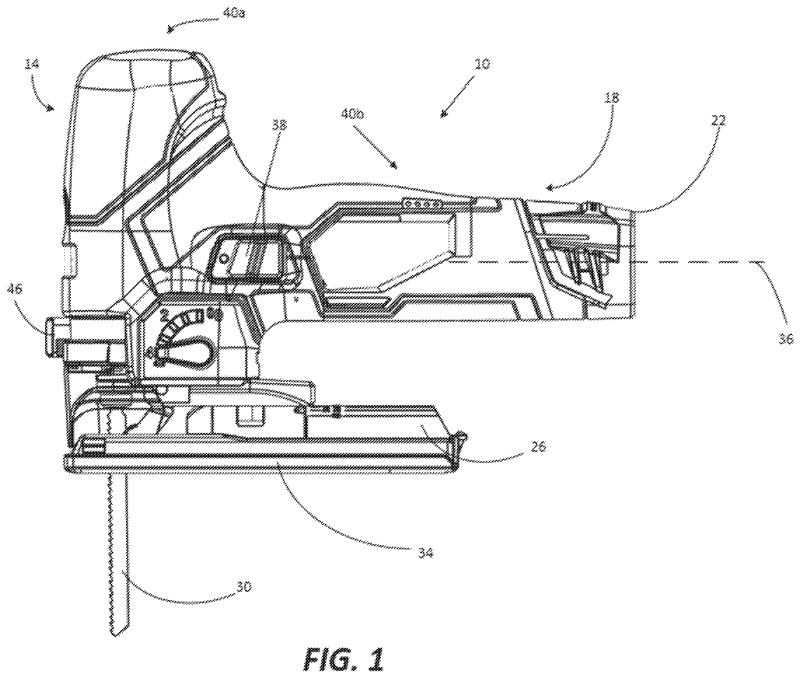

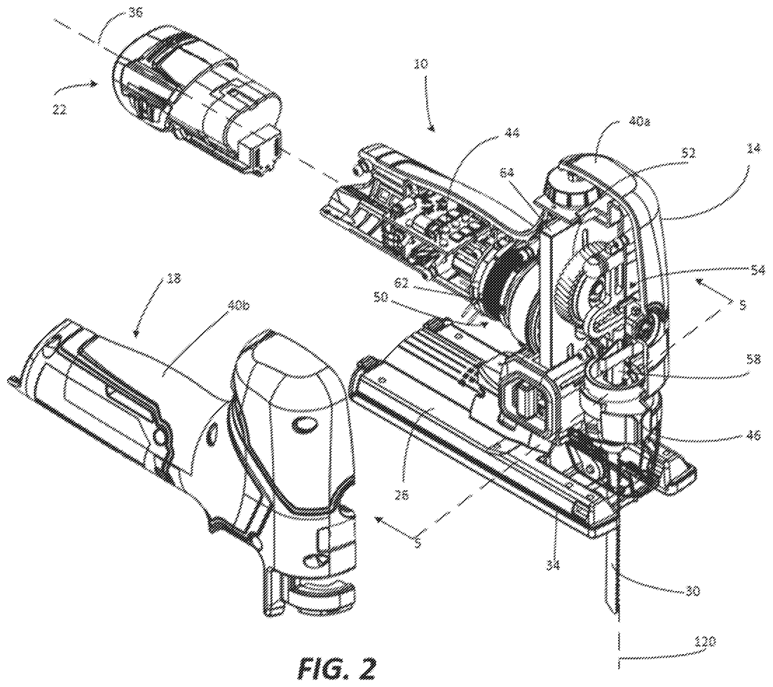

FIG. 1 illustrates a power tool, such as a jigsaw 10, including a housing 14, a handle 18 extending from the housing 14 in a generally transverse direction, a battery pack 22 removably coupled to the handle 18, a foot plate 26 pivotably coupled to the housing 14 and configured to support the housing 14 relative to a workpiece during a cutting operation, and a saw blade 30 protruding from the housing 14 and the foot plate 26. The jigsaw 10 includes a drive assembly 50 (FIG. 2) powered by the battery pack 22 and operable to impart reciprocating motion to the saw blade 30 along a cutting axis 120 for cutting of a workpiece. The jigsaw 10 defines a handle axis 36 extending in the direction of the handle 18.

With reference to FIGS. 1 and 2, the handle 18 receives the battery pack 22 along the handle axis 36 and supports an electronic control unit 44 (e.g., a printed circuit board with one or more microprocessors and/or field-effect transistors). The electronic control unit 44 is disposed between the battery pack 22 and the drive assembly 50 in a direction along the handle axis 36. The jigsaw 10 also includes gripping surfaces 40a, 40b disposed on the housing 14 and the handle 18, respectively, and are graspable by a user to operate and maneuver the jigsaw 10 relative to a workpiece. The gripping surfaces 40a, 40b, in addition to the housing 14 and the handle 18, are composed of a non-conductive material (e.g., plastic with or without an elastomeric overmold). Such a non-conductive material electrically insulates the user should the user inadvertently cut an electrical wire during a cutting operation, thus inhibiting, or at least mitigating, an electrical shock.

With continued reference to FIGS. 1 and 2, the jigsaw 10 further includes an activation switch 38 in electrical communication with the electronic control unit 44 to selectively supply electrical current to the drive assembly 50. Specifically, the activation switch 38 provides an input to the electronic control unit 44 which, in turn, directs electrical current from the battery pack 22 to the drive assembly 50. The activation switch 38 is provided adjacent the handle 18 and disposed radially outward from a brushless direct current (DC) electric motor 62, which is a component of the drive assembly 50 (FIG. 2). The activation switch 38 is slidable between an activated state, in which the battery 22 supplies electrical current to the drive assembly 50, and a deactivated state, in which the drive assembly 50 is deactivated. The activation switch 38 is slidable along a direction that is parallel to the handle axis 36 of the jigsaw 10 (FIG. 1).

With continued reference to FIGS. 1 and 2, the jigsaw 10 further includes a quick-disconnect mechanism or a blade ejection mechanism 46 disposed on the housing 14. The blade ejection mechanism 46 is pivotable about an output spindle 58 (i.e., a saw bar) and is configured to selectively lock the saw blade 30 to the output spindle 58. Specifically, the blade ejection mechanism 46 is adjustable from a locked position, in which the saw blade 30 is inhibited from being removed from the output spindle 58, and an unlocked position, in which the saw blade 30 is permitted to be removed from the output spindle 58. The blade ejection mechanism 46 is biased toward the locked position.

With reference to FIG. 2, the drive assembly 50 of the jigsaw 10 is disposed within the housing 14 and the handle 18. The drive assembly 50 includes the motor 62, a transmission 52 driven by the motor 62, the output spindle 58 to which the saw blade 30 is removably secured, and a scotch yoke mechanism 54 that transfers the rotational motion of the transmission 52 to a reciprocating motion of the output spindle 58. A frame 64 is disposed within the housing 14 and supports the motor 62 and the transmission 52 within the housing 14. The frame 64 is composed of a non-conductive material (e.g., plastic) like the housing 14 and the handle 18. Such a non-conductive material electrically insulates the user should the user inadvertently cut an electrical wire during a cutting operation, thus inhibiting, or at least mitigating, an electrical shock.

During operation, a user may grasp the gripping surfaces 40a, 40b of the housing 14 and the handle 18 to maneuver the jigsaw 10 relative to a workpiece. The user may rest the jigsaw 10 on the workpiece via the foot plate 26 and align the saw blade 30 with the desired cut. The saw blade 30 reciprocates in response to the user sliding the activation switch 38 into the activated state. Specifically, the user slides the activation switch 38 from the non-activated state to the activated state, causing the motor 62 to drive the transmission 52 and reciprocate the saw blade 30.

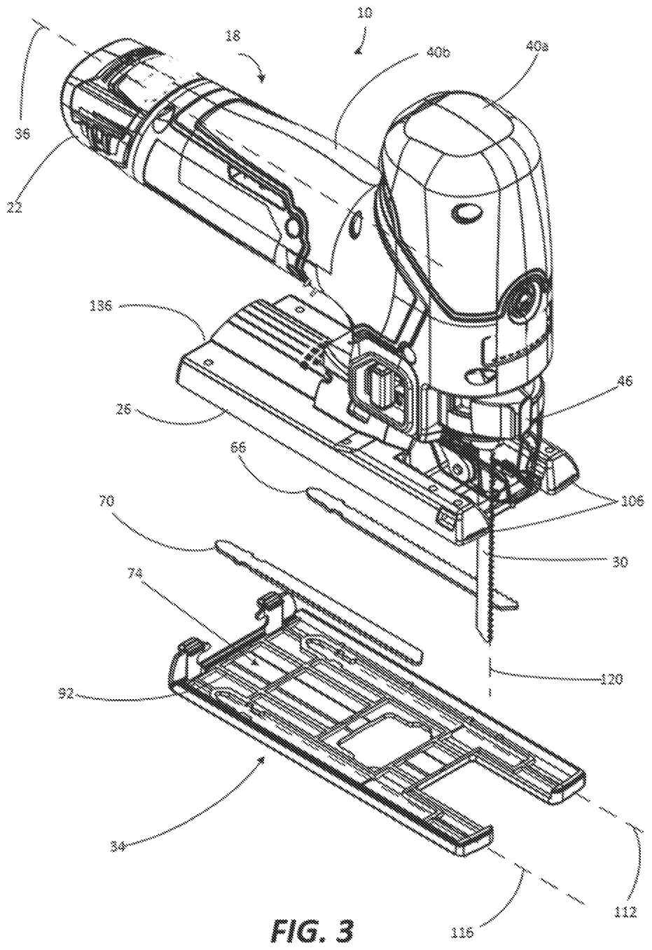

With reference to FIG. 3, the jigsaw 10 also includes an anti-marring shoe 34 attachable to the foot plate 26. In some embodiments of the jigsaw 10, the foot plate 26 is made from a metal, whereas the shoe 34 at least includes a non-metal, low-friction bottom surface to facilitate sliding movement of the jigsaw 10 along a workpiece during a cutting operation. Further, the shoe 34 is capable of storing replacement saw blades 66, 70 therein should the primary saw blade 30 break or become unacceptably worn.

The shoe 34 is selectively coupled to the foot plate 26 and is configured to inhibit the foot plate 26 from marring a workpiece. The user, for example, may choose to attach the shoe 34 to the foot plate 26 when working on a finished workpiece to avoid inadvertently scratching and damaging the workpiece with the foot plate 26. As such, the shoe 34 is disposed between the foot plate 26 and the workpiece when the shoe 34 is coupled to the foot plate 26.

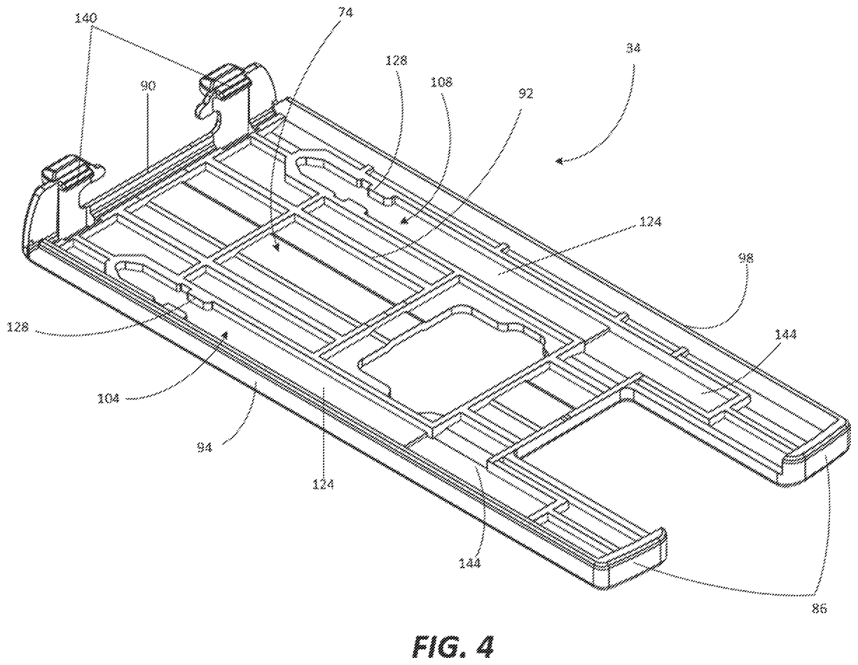

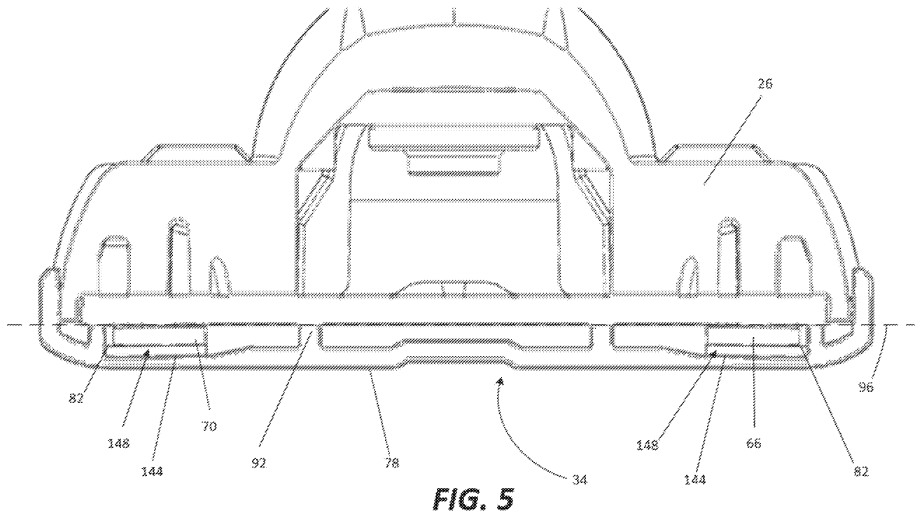

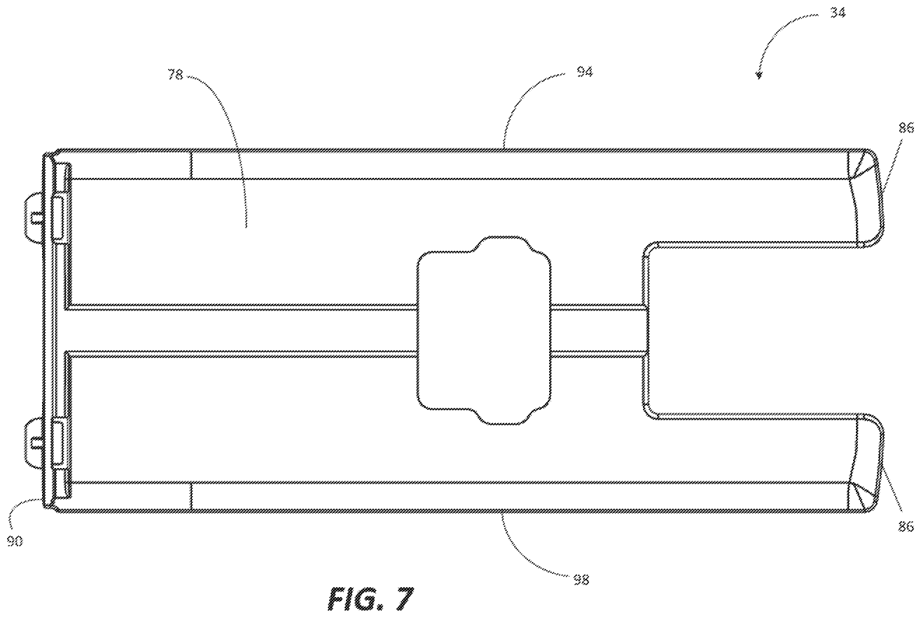

With reference to FIGS. 4-8, the shoe 34 has a bottom surface 78 (FIG. 7) that is configured to contact the workpiece and a top surface 82 (FIG. 4) opposite the bottom surface 78 that engages the foot plate 26. The shoe 34 further includes a front wall 86 and a rear wall 90 that both extend upward from the top surface 82 along a perimeter of the shoe 34. A first side wall 94 and a second side wall 98 also extend upward from the top surface 82 along a perimeter of the shoe 34. In some embodiments of the shoe 34, the first side wall 94 and the second side wall 98 are parallel to each other and extend between the front wall 86 and the rear wall 90. Furthermore, the front wall 86 and the rear wall 90 are parallel to each other. Lastly, a plurality of ribs 92 extend upward from the top surface 82 to provide rigidity and strength to the shoe 34. The ribs 92 also abut against the foot plate 26, thereby defining an abutment plane 96 (FIG. 5), while the front wall 86, the rear wall 90, the first side wall 94, and the second side wall 98 all encase at least a portion of the foot plate 26.

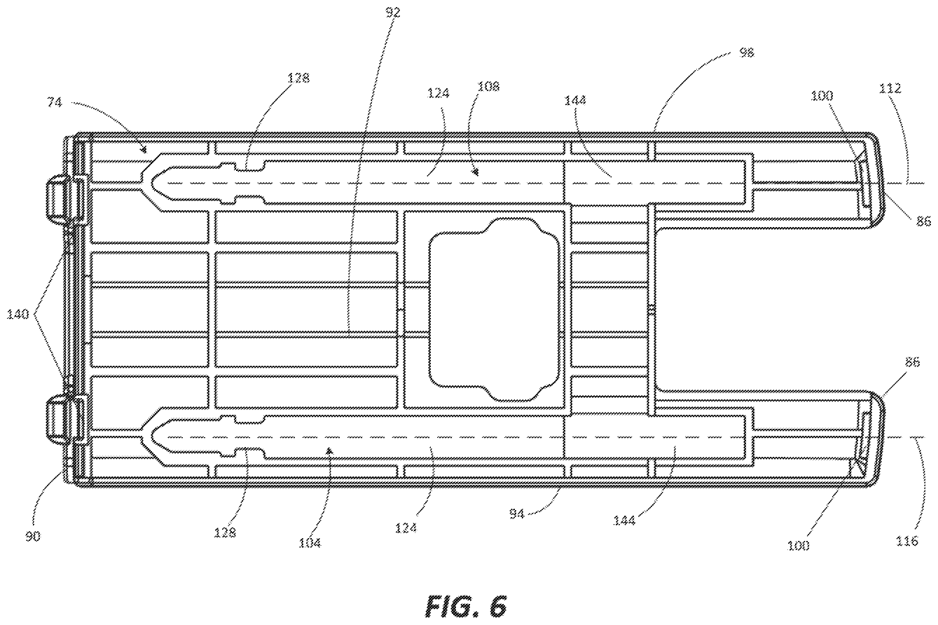

With particular reference to FIG. 6, the front wall 86 includes a pair of protrusions 100 that are receivable within corresponding elongated apertures 106 (FIG. 3) in the foot plate 26. Likewise, the rear wall 90 includes a pair of protrusions 140 that are engageable with a shoulder 136 (FIG. 3) of the foot plate 26. In other embodiments, the protrusions 140 of the rear wall 90 may alternatively be received within corresponding slots or apertures in the foot plate 26. When attaching the shoe 34 to the foot plate 26, the user simply hooks the front wall 86 around the foot plate 26, such that the elongated apertures 106 of the foot plate 26 receive the respective protrusions 100 of the front wall 86. At this point, the user pivots the rear wall 90 toward the foot plate 26 until the protrusions 140 of the rear wall 90 engage the shoulder 136 of the foot plate 26. Specifically, the protrusions 140 mechanically interfere with the foot plate 26, such that the rear wall 90 (i) bends as the foot plate 26 exerts a force substantially perpendicular to the rear wall 90 via the protrusions 140 and (ii) rebounds toward a relaxed position when the protrusions 140 move beyond the shoulder 136 of the foot plate 26. To remove the shoe 34, the user simply pivots the protrusions 140 toward a bent position when the protrusions 140 are no longer engaged with the shoulder 136 of the foot plate 26. At this point, the shoe 34 is pivotable away and removable from the foot plate 26.

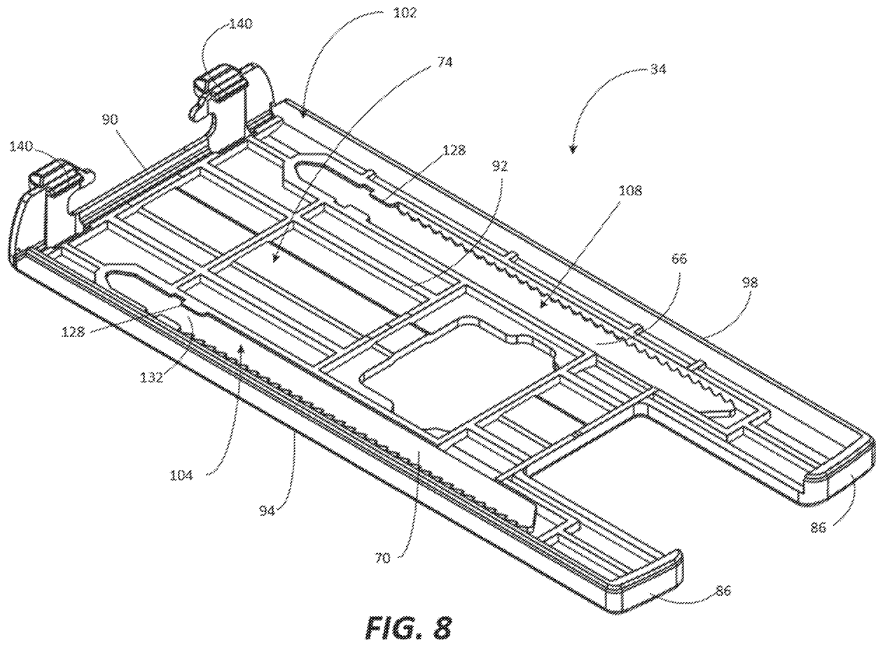

With continued reference to FIGS. 4-8, the shoe 34 also includes a blade accommodating region 74 located on the top surface 82 of the shoe 34. The blade accommodating region 74 contains a first blade receptacle 104 (FIG. 4) that can receive a first replacement blade 66 (FIG. 8) and a second blade receptacle 108 that can receive a second replacement blade 70. Therefore, when the shoe 34 is attached to the foot plate 26, the first replacement blade 66 and the second replacement blade 70 are disposed between the foot plate 26 and the top surface 82 of the shoe 34 (FIG. 5). That said, the first replacement blade 66 and the second replacement blade 70 rest atop the top surface 82 and do not extend beyond the abutment plane 96. In other words, the first replacement blade 66 and the second replacement blade 70 rest sub-flush from the abutment plane 96.

With reference to FIG. 6, the first blade receptacle 104 defines a first longitudinal axis 112 and is disposed adjacent the first side wall 94. Similarly, the second blade receptacle 108 defines a second longitudinal axis 116 and is disposed adjacent the second side wall 98. The first longitudinal axis 112 is parallel to the second longitudinal axis 116. In some embodiments of the shoe 34, the first longitudinal axis 112, the second longitudinal axis 116, and the handle axis 36 are all parallel to each other, as shown in FIG. 3. Furthermore, the first blade receptacle 104 and the second blade receptacle 108 are disposed on opposite sides of the cutting axis 120 (FIG. 3).

With reference to FIG. 4, the first and second blade receptacles 104, 108 each include a channel portion 124 that receives the serrated bodies of the replacement saw blades 66, 70, a neck portion 128 disposed at one end of the channel portion 124, and a sunken shelf 144 disposed at an opposite end of the channel portion 124. The shelf 144 is spaced away from the replacement saw blade 66, 70, defining an air gap 148 (FIG. 5) between the replacement saw blades 66, 70 and the shelf 144. Each neck portion 128 snugly receives a tang 132 of the replacement saw blades 66, 70 to inhibit the replacement saw blades 66, 70 from inadvertently dislodging from the blade accommodating region 74 during operation.

A user may use different techniques to remove either of the replacement saw blades 66, 70 from the respective blade receptacles 104, 108 if needed. In one option, the user may simply apply a downward force onto the desired replacement saw blade 66, 70 opposite the shelf 144, at which point the replacement saw blade 66, 70 pivots into the shelf 144 and the tang 132 of the replacement saw blade 66, 70 is removed from the neck portion 128. In another option, the user may simply insert a finger within the air gap 148 and under the replacement saw blade 66, 70 and apply an upward force on the desired replacement saw blade 66, 70, at which point the replacement saw blade 66, 70 pivots about the neck portion 128 to remove the tang 132 of the replacement saw blade 66, 70 therefrom. Finally, in another option, the user may simply insert two fingers within the air gap 148 adjacent the shelf 144 and apply a rotational force about the longitudinal axis 112, 116, at which point the desired replacement saw blade 66, 70 rotates out of the channel 124.

Although the invention has been described in detail with reference to certain preferred embodiments, variations and modifications exist within the scope and spirit of one or more independent aspects of the invention as described.

Various features of the invention are set forth in the following claims.

What is claimed is:

1. A jigsaw comprising:
a housing;
a drive assembly disposed within the housing and selectively driven by a power source;
an output spindle to which a saw blade is attachable and driven in a reciprocating manner by the drive assembly;
a foot plate coupled to the housing and configured to support the housing relative to a workpiece during a cutting operation; and
a shoe removably coupled to the foot plate and configured to contact the workpiece during a cutting operation,
wherein the shoe includes a blade accommodating region within which at least one replacement saw blade is receivable for storage.

2. The jigsaw of claim 1, wherein the shoe includes a bottom surface configured to face the workpiece and a top surface opposite the bottom surface.

3. The jigsaw of claim 2, wherein the blade accommodating region is located on the top surface of the shoe.

4. The jigsaw of claim 3, wherein a replacement saw blade is disposed between the top surface and the foot plate when the shoe is coupled to the foot plate.

5. The jigsaw of claim 1, wherein the blade accommodating region includes a first blade receptacle and a second blade receptacle in which corresponding replacement saw blades are receivable.

6. The jigsaw of claim 5, wherein the first blade receptacle defines a first longitudinal axis and the second blade receptacle defines a second longitudinal axis that is parallel to the first longitudinal axis.

7. The jigsaw of claim 5, wherein the first blade receptacle and the second blade receptacle are disposed along opposite sides of the shoe.

8. The jigsaw of claim 5, wherein the first blade receptacle and the second blade receptacle each include a channel that accommodates the replacement saw blades and a neck that extends inward from the channel to couple to a tang of the replacement saw blades.

9. The jigsaw of claim 8, wherein the first blade receptacle and the second blade receptacle each include a shelf located opposite from the neck and is spaced away from the replacement saw blades.

10. The jigsaw of claim 1, wherein the shoe further includes at least one projection that is capable of deflecting relative to the shoe upon contacting the foot plate and rebounding to engage the foot plate, thereby coupling the shoe to the foot plate.

11. The jigsaw of claim 1, wherein the shoe is an anti-marring shoe that is composed of a non-metal, low-friction material to facilitate sliding movement of the foot plate along a workpiece during a cutting operation.

12. The jigsaw of claim 2, further comprising a plurality of ribs extending upward from the top surface to abut the foot plate, thereby defining an abutment plane, wherein the replacement saw blade, when received in the blade accommodating region, is sub-flush from the abutment plane.

13. A shoe for use with a jigsaw, the jigsaw including a housing, a foot plate configured to support the housing on a workpiece, and a saw blade driven in a reciprocating manner relative to the foot plate, the shoe comprising:
a bottom surface configured to face and abut the workpiece;
a top surface opposite the bottom surface;
a rear wall and a front wall, both of which extend upward from the top surface to encase at least a portion of the foot plate;
a first side wall and a second side wall, both of extend between the rear wall and the front wall; and
a blade accommodating region disposed adjacent the top surface configured to receive at least one replacement saw blade for storage, wherein the blade accommodating region is disposed between the top surface and the foot plate.

14. The shoe of claim 13, wherein the blade accommodating region includes a first blade receptacle and a second blade receptacle.

15. The shoe of claim 14, wherein the first blade receptacle defines a first longitudinal axis and the second blade receptacle defines a second longitudinal axis that is parallel to the first longitudinal axis.

16. The shoe of claim 14, wherein the first blade receptacle and the second blade receptacle are disposed on opposite sides of the shoe.

17. The shoe of claim 16, wherein the first blade receptacle is disposed adjacent the first side wall and the second blade receptacle is disposed adjacent the second side wall.

18. The shoe of claim 14, wherein the first blade receptacle and the second blade receptacle each include a channel that accommodates the replacement saw blades and a neck that extends inward from the channel to couple to a tang of the replacement saw blades.

19. The shoe of claim 18, wherein the first blade receptacle and the second blade receptacle each include a shelf located opposite from the neck and is spaced away from the replacement saw blades.

20. The shoe of claim 13, further comprising a plurality of ribs extending upward from the top surface to abut the foot plate, thereby defining an abutment plane, wherein the replacement saw blade, when received in the blade accommodating region for storage, is sub-flush from the abutment plane.
